(19) United States
(12) Patent Application Publication
(10) Pub. No.: US 2023/0126311 A1
(43) Pub. Date: Apr. 27, 2023

(54) CABLE CONNECTOR WITH WATERPROOF MECHANISM

(71) Applicant: JESS-LINK PRODUCTS CO., LTD., New Taipei City (TW)

(72) Inventors: Hsu-Feng CHANG, New Taipei City (TW); Shih-Tai CHANG, New Taipei City (TW); Yu-Sheng CHIEN, New Taipei City (TW)

(21) Appl. No.: 17/538,002

(22) Filed: Nov. 30, 2021

(30) Foreign Application Priority Data
Oct. 25, 2021 (TW) 110139534

(51) Int. Cl. H01R 13/52; H01R 13/502; H01R 13/629

(52) U.S. Cl. CPC H01R 13/5205; H01R 13/5213; H01R 13/502; H01R 13/629

(57) ABSTRACT

A cable connector includes a cable, a cover body, and a sealing member. The cable has multiple core wires and a cover layer. The cover layer covers a part of each core wire. An uncovered part of each core wire defines a naked section. The cover body covers the cover layer and a part of each naked section, and is formed with a hole corresponding to positions of the naked sections. The sealing member is disposed in the hole and seals a gap between any two of the naked sections adjacent to each other. Therefore, liquid such as water may be prevented from infiltrating into the connector along a periphery of each core wire.

### BACKGROUND

### Technical Field

The disclosure relates to a cable connector, particularly to a cable connector with a waterproof mechanism.

### Description of Related Art

A cable connector includes a male plug and a female socket. A waterproof effect can be accomplished by both a waterproof washer and a waterproof structure in the male plug and the female socket and the tight connection between the male plug and the female socket.

However, although the related-art cable connector possesses the waterproof function, it is still not good enough. Liquid such as water may enter the connector not only through the male plug and the female socket, but also through the joint between the male plug and the female socket. Also, when the cover layer of a cable is broken, liquid may infiltrate into the connector along a periphery of each core wire to cause failure of waterproofing.

In view of this, the inventors have devoted themselves to the above-mentioned prior art, researched intensively and cooperated with the application of science to try to solve the above-mentioned problems.

### SUMMARY

An object of the disclosure is to provide a cable connector with a waterproof mechanism, which may prevent liquid such as water from infiltrating into the connector along a periphery of each core wire.

To accomplish the above object, the disclosure provides a cable connector with a waterproof mechanism, which includes a cable, a cover body, and a sealing member. The cable has multiple core wires and a cover layer. The cover layer covers a part of each core wire. An uncovered part of each core wire defines a naked section. The cover body covers the cover layer and a part of each naked section, and is formed with a hole corresponding to positions of the naked sections. The sealing member is disposed in the hole and seals a gap between any two of the naked sections adjacent to each other.

The disclosure further has the following functions. The enlarged troughs make the sealing member and the cover body firmly connected together. The through hole disposed in the protrusive section allows another sealing member to be filled to form a double waterproof effect.

### BRIEF DESCRIPTION OF THE DRAWINGS

FIG. 1 is a perspective view of the cable connector of the disclosure before filling the sealing member;

FIG. 2 is a perspective view of the cable connector of the disclosure after filling the sealing member;

FIG. 3 is a cross-sectional view along line 3-3 in FIG. 2;

FIG. 4 is a cross-sectional view along line 4-4 in FIG. 2;

FIG. 5 is an exploded view of another embodiment of the disclosure;

FIG. 6 is an assembled view of the another embodiment of the disclosure;

FIG. 7 is a perspective view of still another embodiment of the disclosure before filling the sealing member;

FIG. 8 is a cross-sectional view of the still another embodiment of the disclosure after filling the sealing member; and

FIG. 9 is an exploded view of yet another embodiment of the cover body of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

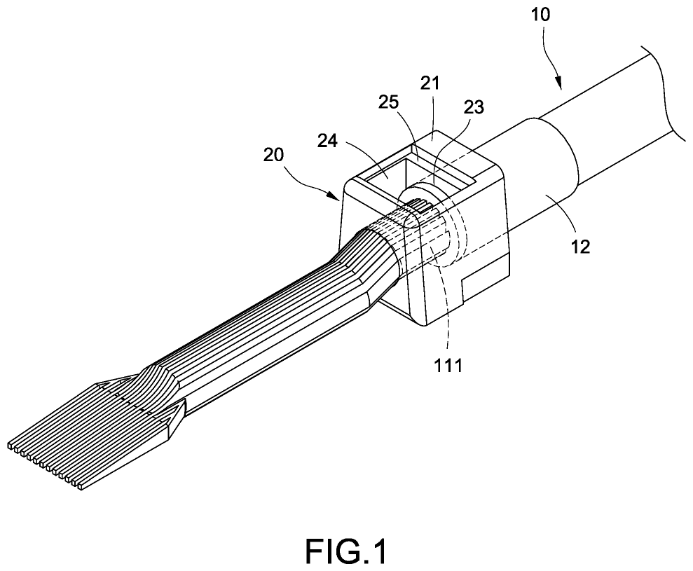

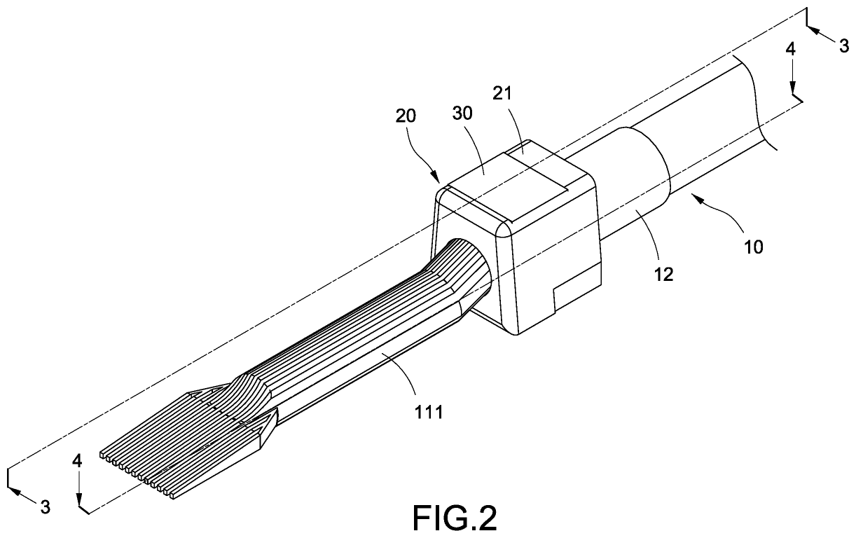

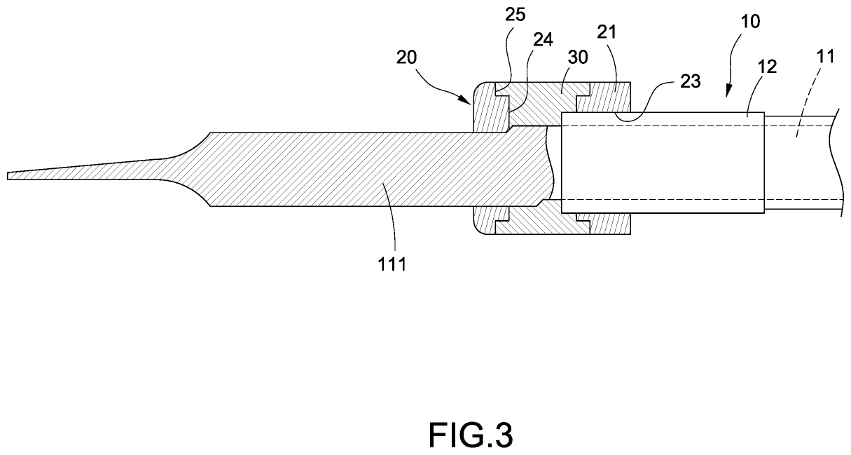

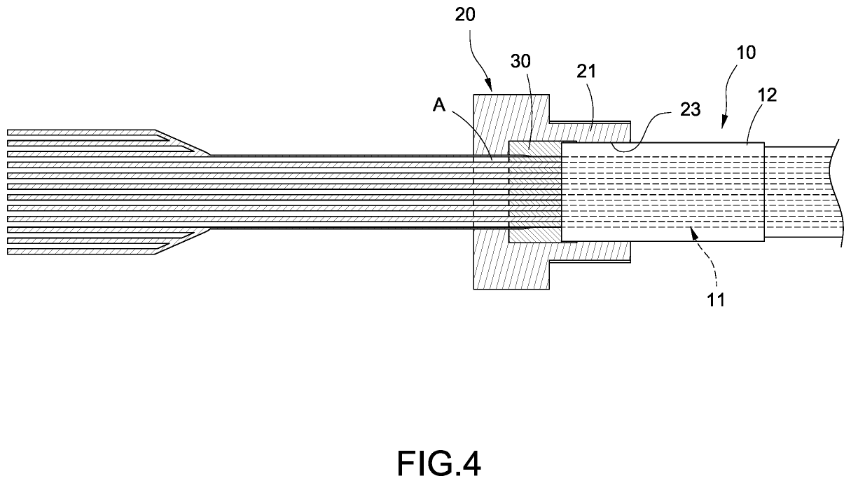

Please refer to FIGS. 1-4. The disclosure provides a cable connector with a waterproof mechanism, which includes a cable 10, a cover body 20 and a sealing member 30.

The cable 10 has multiple core wires 11 and a cover layer 12. Each core wire 11 has a conductor and an enamel layer (not shown in figures) covering the conductor. The cover layer 12 covers a part of each core wire 11. An uncovered part of each core wire 11 defines a naked section 111, respectively.

The cover body 20 covers the cover layer 12 and a part of each naked section 111, and is formed by insulative material and in a manner of injecting hot-melt adhesive. The cover body 20 has a connecting section 21. The connecting section 21 is formed with an axial hole 23 penetrating through the center thereof. The connecting section 21 is further formed with a hole 24 which is perpendicular to and communicates with the axial hole 23. The hole 24 of the embodiment is a communicating hole which penetrates through the connecting section 21 and communicates with the axial hole 23. The peripheries of the top and the bottom of the hole 24 of the connecting section 21 of the cover body 20 are formed with an enlarged trough 25, respectively.

In detail, the cover body 20 covers a part of the cover layer 12 adjacent to the naked sections 111 and a part of each naked section 111 adjacent to the cover layer 12 through the axial hole 23 of the connecting section 21. The hole 24 is arranged correspondingly to positions of the naked sections 111. The other part of each naked section 111 penetrates through the axial hole 23 to project from the connecting section 21.

The sealing member 30 is disposed in the hole 24 and seals a gap A between any two of the naked sections 111 adjacent to each other. In the embodiment, the sealing member 30 is a waterproof adhesive, which is injected into the cover body 20 via the hole 24 to fill the gap A between any two of the naked sections 111 adjacent to each other through the fluidity, and forms the sealing member 30 after solidification. The waterproof adhesive may be silicone, epoxy resin, polyurethane resin, butyl rubber, chlorosulfonated polyethylene rubber, natural rubber, acrylic rubber, neoprene, or a combination of the materials. In addition, the sealing member 30 not only fills in the hole 24 but also spills over to the enlarged trough 25 to make the sealing member 30 and the cover body 20 be firmly connected together.

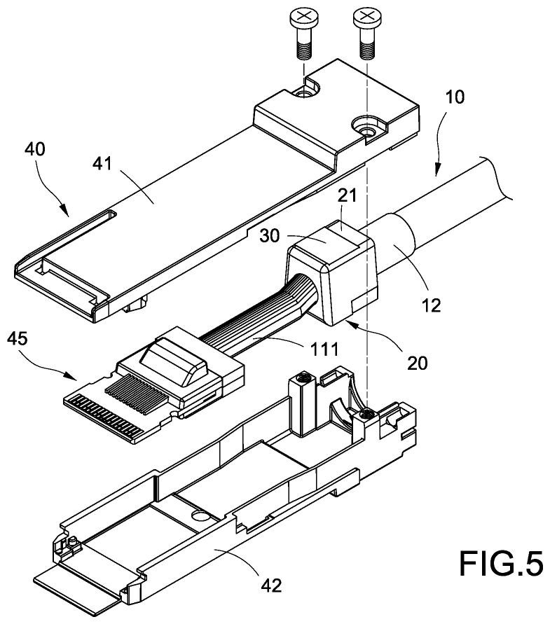

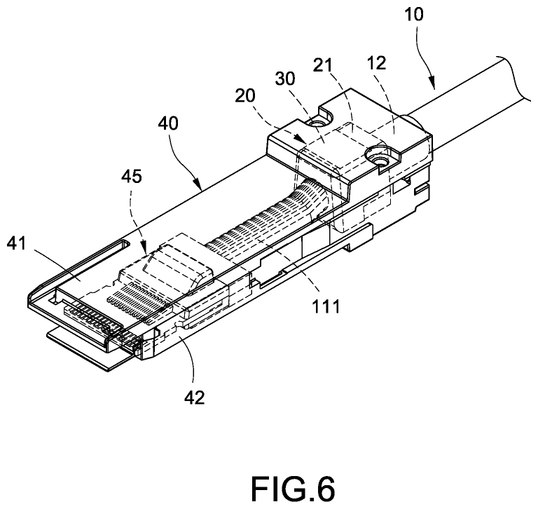

Please refer to FIGS. 5 and 6. The cable connector with a waterproof mechanism of the disclosure further includes a case 40 and an insertion portion 45. The insertion portion 45 is assembled by the elements including a circuit board, and an insert molding plastic, etc. An end of the circuit is electrically connected to an end of each naked section 111 of the core wires 11. The case 40 covers outsides of the cover body 20, the insertion portion 45 and the naked sections 111. The case 40 of the embodiment is made of the material such as a zinc alloy, etc., and includes an upper case seat 41 and a lower case seat 42. When assembling, the cover body 20, the insertion portion 45 and the naked sections 111 are placed in the lower case seat 42, then the upper case seat 41 is correspondingly connected to the lower case seat 42, and that is screwed and fixed by fasteners such as screws. As a result, the cover body 20 and the naked sections 111 which are not covered by the cover body 20 are accommodated inside the upper case seat 41 and the lower case seat 42.

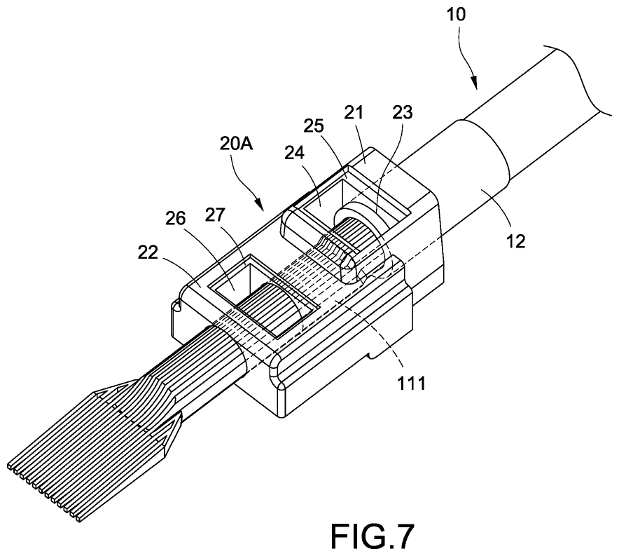

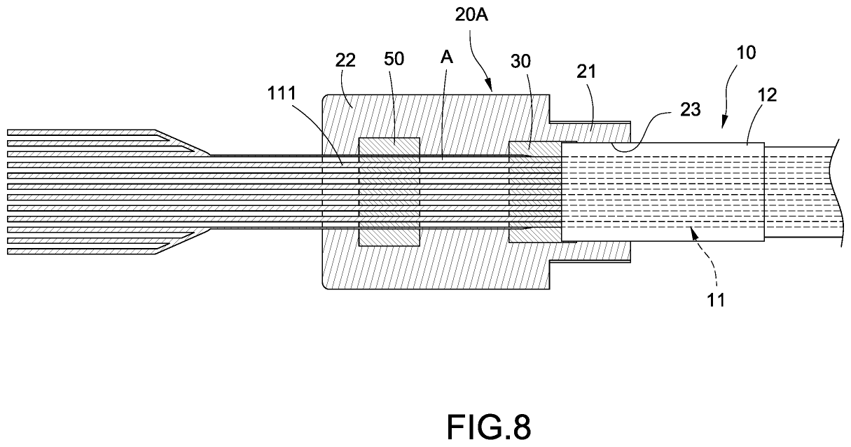

Please refer to FIGS. 7 and 8. Besides the above embodiments, the cover body 20A of the embodiment of the cable connector with a waterproof mechanism of the disclosure further includes a protrusive section 22 axially extended from the connecting section 21. The connecting section 21 and the protrusive section 22 are formed with an axial hole 23 penetrating through the centers thereof. The connecting section 21 is further formed with a hole 24 which is perpendicular to and communicates with the axial hole 23. The protrusive section 22 is formed with a through hole 26 which is perpendicular to and communicates with the axial hole 23. A periphery of the top and the bottom of the through hole 26 of the protrusive section 22 is formed with an enlarged trough 27, respectively. The waterproof adhesive is injected into the cover body 20 via the through hole 26 to fill the gap A between any two of the naked sections 11 adjacent to each other by the fluidity, and forms another sealing member 50 after solidification. As a result, a double waterproof effect is achieved.

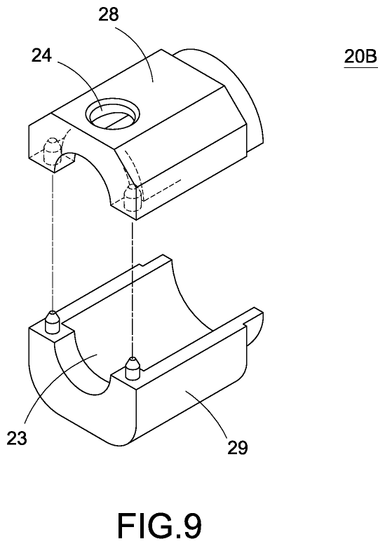

Please refer to FIG. 9. The cover body 20B of the embodiment includes an upper cover shell 28 and a lower cover shell 29. The upper cover shell 28 is correspondingly connected to the lower cover shell 29. The axial hole 23 is formed between the upper cover shell 28 and a lower cover shell 29. The upper cover shell 28 is formed with a hole 24 communicating with the axial hole 23. The hole 24 of the embodiment is a blind hole for avoiding leakage of the waterproof adhesive when the waterproof adhesive is being filled into the cover body 20B.

While this disclosure has been described by means of specific embodiments, numerous modifications and variations could be made thereto by those skilled in the art without departing from the scope and spirit of this disclosure set forth in the claims.

What is claimed is:

1. A cable connector with a waterproof mechanism, the cable connector comprising:
a cable, comprising multiple core wires and a cover layer, the cover layer covering a part of each core wire, and a naked section defined on an uncovered part of each core wire;
a cover body, covering the cover layer and a part of each naked section, and comprising a hole disposed corresponding to positions of the naked sections; and
a sealing member, disposed in the hole, and sealing a gap between any two of the naked sections adjacent to each other.

2. The cable connector of claim 1, wherein the sealing member comprises a waterproof adhesive after solidification.

3. The cable connector of claim 1, wherein an enlarged trough is respectively disposed on peripheries of a top and a bottom of the hole of the cover body, and the sealing member covers each enlarged trough.

4. The cable connector of claim 1, wherein the cover body comprises a hot-melt adhesive, and the hole is a communicating hole penetrating through the cover body.

5. The cable connector of claim 1, wherein the cover body comprises an upper cover shell and a lower cover shell, the upper cover shell is correspondingly connected to the lower cover shell, an axial hole is disposed between the upper cover shell and the lower cover shell, and the hole is a blind hole communicating with the axial hole.

6. The cable connector of claim 1, wherein the cover body comprises a connecting section, an axial hole is disposed on the connecting section and penetrates through a center of the connecting section, and the hole penetrates through the connecting section and communicates with the axial hole.

7. The cable connector of claim 6, wherein the cover body covers a part of the cover layer adjacent to each naked section and a part of each naked section adjacent to the cover layer through the axial hole.

8. The cable connector of claim 7, wherein another part of each naked section projects to outside of the connecting section from the axial hole.

9. The cable connector of claim 1, wherein the cover body further comprises a connecting section and a protrusive section extended from the connecting section, an axial hole is collectively disposed in the connecting section and the protrusive section penetrating through centers of those, a through hole is disposed on the protrusive section communicating with the axial hole, and another sealing member is disposed in the through hole sealing the gap between any two of the naked sections adjacent to each other.

10. The cable connector of claim 1, further comprising: a case and an insertion portion, the insertion portion electrically connected to the naked sections, the case covers the cover body, the insertion portion, and the naked sections.
